(19) United States
(12) Patent Application Publication
(10) Pub. No.: US 2012/0138541 A1
(43) Pub. Date: Jun. 7, 2012

(54) Systems, Compositions, and Methods For Dewatering Mine Tailings

(76) Inventors: David C. Rennard, Houston, TX (US); Robert D. Kaminsky, Houston, TX (US); Thomas R. Palmer, Houston, TX (US)

(21) Appl. No.: 13/272,819

(22) Filed: Oct. 13, 2011

Related U.S. Application Data
(60) Provisional application No. 61/420,129, filed on Dec. 6, 2010.

(51) Int. Cl. C02F 9/04; C02F 1/52; B01D 39/02; C09K 3/00; C02F 1/00; C02F 1/38; C02F 103/10

(52) U.S. Cl. 210/723; 210/767; 210/805; 210/804; 210/787; 210/702; 210/502.1; 210/257.1; 210/207; 252/182.12

(57) ABSTRACT

Systems, compositions, and methods for dewatering and/or increasing a mechanical strength of mine tailings. These systems, compositions, and methods may include combining mine tailings with wicking fibers to form a composite mine tailings mixture. The wicking fibers may provide a conduit for the removal of fluid from the composite mine tailings mixture. The composite mine tailings mixture further may include a binder that may decrease repulsive forces among fine particles that comprise the mine tailings and/or increase attractive forces among the fine particles, leading to a separation of the fine particles from at least a portion of the fluid contained within the composite mine tailings mixture. The composite mine tailings mixture may be placed in a storage or dewatering area as a composite mine tailings mixture deposit, which may include internal structure, such as layers of the composite mine tailings mixture and/or long-range orientation of the wicking fibers contained therein.

### CROSS-REFERENCE TO RELATED APPLICATION

This application claims the priority benefit of U.S. Provisional Patent Application 61/420,129 filed Dec. 6, 2010 entitled SYSTEMS, COMPOSITIONS, AND METHODS FOR DEWATERING MINE TAILINGS, the entirety of which is incorporated by reference herein.

### FIELD OF THE DISCLOSURE

The present disclosure is directed generally to systems, compositions, methods for dewatering and/or for increasing a mechanical strength of mine tailings and more particularly to systems and methods that utilize wicking fibers to increase a dewatering rate and/or the mechanical strength of the mine tailings.

### BACKGROUND OF THE DISCLOSURE

Mining operations, which involve the extraction of natural resources from the ground, often produce waste materials, products, and/or streams which also may be referred to as mine tailings. Mine tailings may be produced throughout the lifetime of the mining operation, and as a result, a mining operation may generate a large quantity of mine tailings during the course of the operation. A portion of these mine tailings may take a form that is not readily incorporated back into the natural environment and/or utilized for other purposes and thus may accumulate during the mining operation. In some instances, it may be desirable to recycle and/or treat these mine tailings in order to place them into a form that may serve a useful purpose and/or that may be returned to the natural environment.

As an illustrative, non-exclusive example, an oil sands mining operation, such as one that extracts bitumen from mined oil sands ore, may utilize hot water, caustic chemicals, and air to separate the bitumen from the solids present within the ore. A waste, mine tailings, or fluid tailings stream generated by the oil sands mining operation may include caustic water, sand, fine particles, such as clay particles, and residual bitumen. Over time, the sand may be removed from the fluid tailings stream by gravitational separation. However, the high pH of the mixture of water and caustic chemicals may cause delamination and charging of the clay particles, resulting in a colloidal clay suspension called thin fine tailings (TFT) that typically includes 6-14 wt % solids in water. With additional settling time (on the order of 1-2 years), a portion of the water present in the TFT may separate, leaving mature fine tailings (MFT) that include approximately 30 wt % solids in water. However, the chemical composition of the MFT is such that water is sequestered into the mature fine tailings much more rapidly than it is released, leading to a quasi-stable mine tailings slurry.

Composite tailings (CT) and/or non-segregating tailings (NST) processes may be utilized to increase the solids content of mine tailings above 30 wt % and/or increase the mechanical strength of a mine tailings deposit, providing a mechanism by which the mine tailings may be converted into a trafficable surface (Advances in Oil Sands Tailings Research, Fine Tailings Fundamentals Consortium, Vol 111-3, 1995). These technologies may include combining MFT and/or flocculated TFT with sand and gypsum, or another coagulant, to destabilize the colloidal clay suspension and provide for additional dewatering of the mine tailings. However, these technologies have several commercial limitations, including a high demand for sand, a tendency to separate under shear induced by pumping, difficulty in scaling up from the laboratory scale, and an imbalance between the amount of sand needed to meet dewatering rate goals and the amount of sand needed to meet mechanical strength goals.

Sand is typically produced within the mining operation; however, only a finite supply exists and this supply is valuable as a construction material at the mine site. A sand-to-fines ratio in the CT and/or NST processes is typically between 3 and 7, and these high sand-to-fines ratios may lead to a depletion of the sand supply. Similarly, the tendency of CT and/or NST to separate under shear loads and the unpredictability when compared to laboratory experiments may lead to lower than expected performance in the field. In addition, the amount of sand needed to meet dewatering rate goals may be greater than the amount of sand needed to meet mechanical strength goals and may actually decrease the mechanical strength of the mine tailings deposit. Thus, there exists a need for technologies that may reliably separate the water from the other components of the mine tailings, recycle at least a portion of the materials that are included in the mine tailings, and/or transform the mine tailings into a useful form, such as a trafficable surface, while meeting mechanical strength and dewatering rate goals and decreasing the overall sand requirement.

### SUMMARY OF THE DISCLOSURE

The present disclosure is directed to systems, compositions, and methods for dewatering and/or increasing a mechanical strength of a mine tailings deposit. These systems, compositions, and methods may include combining mine tailings with wicking fibers to form a composite mine tailings mixture, depositing the composite mine tailings mixture in a storage and/or dewatering area as a composite mine tailings deposit, and/or removing at least a portion of the water present within the composite mine tailings deposit. The presence of wicking fibers within the composite mine tailings mixture may provide a conduit for fluid removal from the composite mine tailings mixture deposit, leading to an increased dewatering rate when compared to a mine tailings deposit that does not include the wicking fibers, and/or may increase the mechanical strength of the deposit. In some embodiments, the composite mine tailings mixture also may include a binder that may destabilize a suspension of fine particles within the mine tailings, leading to separation of the fine particles from at least a portion of the water present within the composite mine tailings mixture deposit. In some embodiments, the composite mine tailings mixture may further include sand. In some embodiments, a sand-to-fines ratio within the composite mine tailings mixture is less than 5 to 1.

In some embodiments, at least a portion of the wicking fibers present within the composite mine tailings mixture deposit may be oriented and/or aligned along at least a primary wicking direction. In some embodiments, the wicking fibers may include bio-fibers. In some embodiments, the composite mine tailings mixture deposit may include a plurality of layers. In some embodiments, the plurality of layers may include a plurality of layers of the composite mine tailings mixture. In some embodiments, at least a portion of the plurality of layers may include a different concentration of wicking fibers than another portion of the plurality of layers. In some embodiments, at least one of the plurality of layers may not include wicking fibers. In some embodiments, at least a portion of the composite mine tailings mixture deposit may be covered with a capping material. In some embodiments, at least a portion of the water that is removed from the composite mine tailings mixture deposit during the dewatering may be utilized within a mine tailings treatment system to create the composite mine tailings mixture and/or recycled to a mining operation, such as a mining operation that creates mine tailings.

### BRIEF DESCRIPTION OF THE DRAWINGS

FIG. 1 is a schematic representation of illustrative, non-exclusive examples of composite mine tailings mixtures according to the present disclosure.

FIG. 2 is a less schematic representation of illustrative, non-exclusive examples of storage areas for the composite mine tailings mixture that may be utilized with the systems and methods according to the present disclosure.

FIG. 3 is a schematic representation of illustrative, non-exclusive examples of mine tailings treatment systems according to the present disclosure.

FIG. 4 is a less schematic representation of illustrative, non-exclusive example of mine tailings treatment systems according to the present disclosure.

FIG. 5 is a schematic representation of composite mine tailings deposit that include two layers according to the present disclosure.

FIG. 6 is a schematic representation of a composite mine tailings deposit that includes two layers according to the present disclosure.

FIG. 7 is a schematic representation of a composite mine tailings deposit that optionally includes two layers according to the present disclosure.

FIG. 8 is a schematic representation of a composite mine tailings deposit that includes three layers according to the present disclosure.

FIG. 9 is a flowchart providing illustrative, non-exclusive examples of methods of producing a composite mine tailings mixture according to the present disclosure.

FIG. 10 is a flowchart providing an illustrative, non-exclusive example of a method of providing mine tailings according to the present disclosure.

### DETAILED DESCRIPTION AND BEST MODE OF THE DISCLOSURE

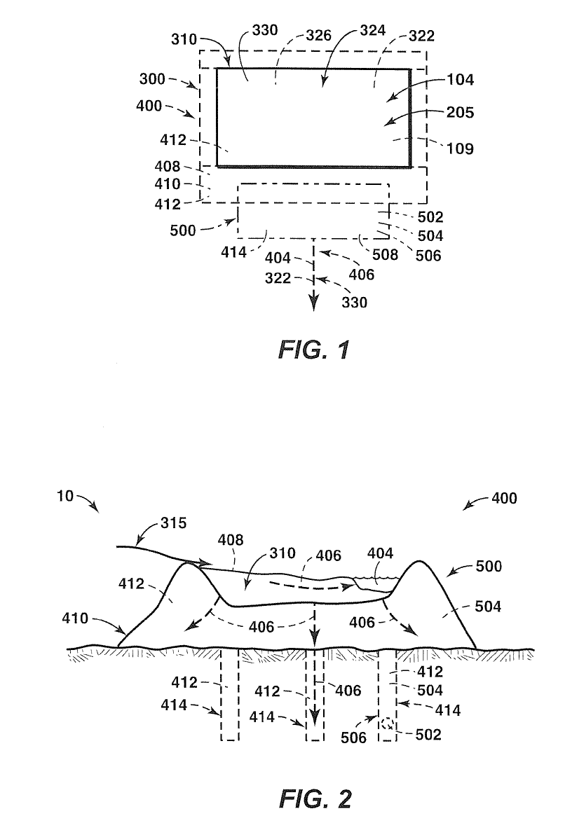

FIG. 1 provides an illustrative, non-exclusive example of a composite mine tailings mixture 310 according to the present disclosure. The composite mine tailings mixture of FIG. 1 also may be referred to as a composite mine tailings composition, a fibrous mine tailings mixture, a wicking mine tailings mixture, percolating composite tailings, percolating mine tailings, percolating tailings, and/or wicking composite tailings. Composite mine tailings mixture 310 may exhibit improved functional properties, such as an increased dewatering, or water drainage, rate, increased mechanical stability, increased shear strength, a lower overall water content, and/or greater long-term stability when compared to TFT and/or MFT. The composite mine tailings mixture includes mine tailings 104, wicking fibers 205, and at least one chemical reagent 324, which may be or include at least one binding agent 326. The binding agent may decrease the chemical stability of the colloidal clay present within the mine tailings, thereby causing agglomeration of the clay particles. The wicking fibers, which may be contained, dispersed, or otherwise distributed within the composite mine tailings mixture, may provide an improved fluid conduction pathway for the removal of water from the composite mine tailings mixture.

As discussed in more detail herein, mine tailings 104 may include a mixture of water 322, sand 412, and/or fine particles 109. An illustrative, non-exclusive example of fine particles according to the present disclosure includes clay particles. Additionally or alternatively, another illustrative, non-exclusive example of fine particles according to the present disclosure include particles with a characteristic diameter of less than 60 micrometers, including particles with a characteristic diameter of less than 55, less than 50, less than 45, less than 44, less than 40, less than 30, between 20-60, between 35-55, or between 40-50 micrometers. As used herein, characteristic diameter may refer to an average, representative, and/or equivalent diameter. As an illustrative, non-exclusive example, when the fine particles include spherical particles, the characteristic diameter may include the diameter of the spherical particles. As another illustrative, non-exclusive example, when the fine particles include non-spherical particles, the characteristic diameter may include another characteristic dimension of the particles, illustrative, non-exclusive examples of which include a maximum dimension or a minimum dimension. As yet another illustrative, non-exclusive example, when the fine particles include non-spherical particles, the characteristic diameter may include the diameter of a sphere that includes a volume similar to the volume of the particles. It is within the scope of the present disclosure that the mine tailings may include a plurality of fine particles that may include a plurality, or distribution, of characteristic diameters and that the characteristic diameter may refer to an average or representative characteristic diameter.

As discussed in more detail herein, mine tailings 104 include solids, including sand, small particles, clay particles, and/or colloidal clay particles, dispersed in a fluid 330, such as water 322. It is within the scope of the present disclosure that the mine tailings may include any suitable fraction, proportion, or weight percentage (wt %) solids in water, illustrative, non-exclusive examples of which include 5-40 wt % solids in water, including 5-20 wt %, 6-14 wt %, 10-30 wt %, 20-40 wt %, 40-60 wt %, 25-35 wt %, approximately 10 wt %, approximately 15 wt %, approximately 20 wt %, approximately 25 wt %, approximately 30 wt %, approximately 35 wt %, or approximately 40 wt % solids in water.

It is within the scope of the present disclosure that the mine tailings may include at least one of fluid fine tailings, thin fine tailings, thickened tailings, mature fine tailings, composite tailings, or non-segregating tailings. As used herein, fluid fine tailings (FFT) may refer to a fluid-containing byproduct of the mining operation that may include at least water, fine particles, and sand and/or other heavy particles. FFT may include a caustic pH that may lead to delamination and surface charging of the fine particles, which may provide a mechanism by which the fine particles form the stable, or colloidal, suspension in the water. Illustrative, non-exclusive examples of the caustic pH of the FFT may include a pH between 8 and 9, including a pH of between 8.1-8.8, between 8.2-8.7, between 8.3-8.5, approximately 8.3, approximately 8.4, or approximately 8.5.

As discussed in more detail herein, at least a portion of the sand and/or other fine particles contained within the FFT may settle with time to produce thin fine tailings (TFT), which may include a solids content of approximately 6-14 wt % solids in water. The TFT may be treated further to remove additional water and produce densified tailings. Illustrative, non-exclusive examples of the solids content of densified tailings may include approximately 20-40 wt % solids in water, including solids contents of 22-37 wt %, 25-35 wt %, 25-30 wt %, 30-35 wt % or 28-33 wt % solids in water.

As an illustrative, non-exclusive example, densified tailings may be produced through gravitational settling of TFT over a densifying time to further dewater the TFT and produce mature fine tailings (MFT). It is within the scope of the present disclosure that the densifying time may include densifying times of greater than 6 months, including densifying times of greater than 9 months, greater than 12 months, greater than 15 months, greater than 18 months, greater than 21 months, greater than 24 months, greater than 30 months, greater than 36 months, between 6-24 months, between 9-18 months, or between 12-24 months. As discussed in more detail herein, the dewatering rate of the MFT decreases dramatically as the water content decreases due to the chemical interactions between the small particles that are suspended within the MFT and between the small particles and the water. Thus, the solids content of the MFT stabilizes at approximately 30 wt % solids in water as water uptake rates become comparable to or greater than dewatering rates.

A chemical reagent 324 and sand may be added to the MFT to form composite tailings (CT). The addition of chemical reagent 324, such as a coagulant or other binding agent 326, may decrease the stability of the colloidal suspension of fine particles contained within the MFT and provide a mechanism for agglomeration and/or flocculation of the fine particles from the MFT mixture. The addition of sand may produce a matrix structure, wherein the sand provides a plurality of fluid pathways for the removal of water from the CT. The binding agent may include any suitable coagulant adapted to decrease the stability of the fine particles suspended in solution. Illustrative, non-exclusive examples of coagulants according to the present disclosure include gypsum, an acid, a base, lime, a multivalent cation, alum, aluminum chlorohydrate, aluminum sulfate, calcium oxide, calcium hydroxide, iron(II) sulfate, iron(III) chloride, polyacrylamide, polydiallyldimethylammonium chloride, sodium aluminate, sodium silicate, chitosan, isinglass, moringa oleifera seeds, gelatin, strychnos, guar gum, and alginates.

As another illustrative, non-exclusive example, densified tailings may be produced by treating TFT with at least one chemical reagent 324, such as a flocculent or other binding agent 326, to form thickened tails (TT). Treatment with a flocculent may destabilize the suspension of colloidal particles contained within the TFT and accelerate the dewatering rate. Any suitable type and/or number of flocculent(s) may be utilized. Illustrative, non-exclusive examples of flocculants according to the present disclosure include at least one of a long-chain polymer flocculent, as well as the coagulants disclosed herein. The TT may further be combined with sand and a coagulant in a process that is substantially similar to that discussed above with respect to CT to produce non-segregating tailings (NST).

Chemical reagent 324, which also may be referred to as and/or may include binding agent 326, such as a flocculent and/or a coagulant, may be present in any suitable amount. As an illustrative, non-exclusive example, the chemical reagent may comprise less than 5 wt % of a total solids content of composite mine tailings mixture 310, including the chemical reagent comprising less than 4 wt %, less than 2.5 wt %, less than 2 wt %, less than 1 wt %, less than 0.5 wt %, less than 0.25 wt %, less than 0.1 wt %, less than 0.01 wt %, between 0.01-1 wt %, between 0.5-2 wt %, or between 1-4 wt % of the total solids content. Composite mine tailings mixture 310 that includes binding agent 326, but with a total binding agent content that is outside of the above illustrative, non-exclusive examples is still within the scope of the present disclosure.

Wicking fibers 205 may include any suitable fiber or structure adapted to provide a hydraulic pathway to improve, increase, and/or facilitate the removal of fluid 330, such as water 322, from composite mine tailings mixture 310. It is within the scope of the present disclosure that the wicking fibers may include or comprise any suitable proportion of the total solids content of the composite mine tailings mixture. As an illustrative, non-exclusive example, the wicking fibers may comprise between 0.0001 and 10 wt % of the total solids content of the composite mine tailings mixture, including 0.1 to 1 wt %, 0.001 to 5 wt %, 5 to 10 wt %, 0.01 to 1 wt %, less than 5 wt %, less than 0.5 wt %, less than 0.05 wt %, or less than 0.005 wt % of the total solids content.

It is also within the scope of the present disclosure that wicking fibers 205 may include a plurality of wicking fibers 205 that include a plurality of fiber lengths that define an average, mean, and/or representative fiber length. Illustrative, non-exclusive examples of average fiber lengths according to the present disclosure include average fiber lengths of less than 2 meters, including average fiber lengths of less than 1 meter, less than 50 cm, less than 25 cm, less than 1 cm, less than 1 mm, less than 0.1 mm, less than 0.01 mm, between 0.01 mm and 2 meters, between 0.1 mm and 1 meter, between 0.01 mm and 1 meter, between 0.1 mm and 50 cm, between 1 mm and 50 cm, between 1 mm and 25 cm, or between 1 cm and 50 cm. These illustrative, non-exclusive examples refer to the fiber lengths when the wicking fibers 205 are mixed with the mine tailings. The length of some wicking fibers, such as bio-matter, may change over time after being mixed with the mine tailings and deposited for a period of time in a storage area, such as after the fibers decompose or otherwise break into shorter lengths.

It is further within the scope of the present disclosure that the plurality of wicking fibers may include one or more characteristic diameters that define an average, mean, and/or representative characteristic fiber diameter. Illustrative, non-exclusive examples of average characteristic fiber diameters according to the present disclosure include average characteristic fiber diameters of less than 2.5 cm, including average characteristic fiber diameters of less than 2 cm, less than 1 cm, less than 5 mm, less than 3 mm, less than 1 mm, or less than 0.5 mm. Wicking fibers with fiber lengths and/or average characteristic fiber diameters that are outside of (i.e., greater than or less than) the above illustrative, non-exclusive examples are still within the scope of the present disclosure.

Wicking fibers 205 may be formed or created from any suitable material and/or structure, including naturally occurring and/or man-made materials and/or structures. As an illustrative, non-exclusive example, wicking fibers 205 may include bio-fibers, such as wood chips, wood slash, wood pulp, grass, straw, hemp, hay, and/or cellulose. As another illustrative, non-exclusive example, wicking fibers 205 may include artificial fibers, such as polymer fibers, polypropylene fibers, glass fibers, plastic fibers, fiberglass, and/or any suitable composite material. Additional illustrative, non-exclusive examples of wicking fibers 205 include fibers and other structures that are formed from rubber, including natural and/or synthetic rubber, and further include fibers, chips, shreds, and/or other pieces of tires or other rubber or plastic products.

It is within the scope of the present disclosure that the wicking fibers may be present within composite mine tailings mixture 310 in their naturally occurring, basic, and/or most common form. However, it is also within the scope of the present disclosure that wicking fibers 205 may be formed into a fabric, a geofabric, a rope, a rod, a capillary rod, a permeable rod, and/or two or more twisted strands of fiber prior to incorporation into the composite mine tailings mixture. It is further within the scope of the present disclosure that wicking fibers 205 may be produced from recycled or reclaimed materials.

As discussed in more detail herein, composite mine tailings mixture 310 further may include sand. It is within the scope of the present disclosure that a portion of the sand present within the composite mine tailings mixture may be supplied with and/or form a part of the mine tailings. However, it is also within the scope of the present disclosure that a portion of the sand present within the composite mine tailings mixture may be from a source other than and/or supplied separately from the mine tailings. The composite mine tailings mixture may include a sand-to-fines ratio (SFR), which is a ratio of the weight of sand 412 in the composite mine tailings mixture to a weight of fine particles 109 in the composite mine tailings mixture. The desired SFR may vary with the composition of the mine tailings, including a concentration, quantity, type, and/or size of the fine particles and/or the nature of chemical reagent 324. Illustrative, non-exclusive examples of composite mine tailings mixture sand-to-fines ratios according to the present disclosure include composite mine tailings mixture sand-to-fines ratios of 0.3 to 8 (which additionally or alternatively may be expressed as 0.3:1 to 8:1), including sand-to-fines ratios of 0.5-7, 0.8-5, 0.5-3.5, 1-3.5, 1.5-3.5, and 1-4.

As shown in dashed lines in FIG. 1, it is within the scope of the present disclosure that composite mine tailings mixture 310 may optionally be contained within, supported by, or otherwise in contact with a storage area 400. Storage area 400 also may optionally be referred to as a containment structure, a dewatering structure, and/or a dewatering area, and may include any suitable structure adapted to contact the composite mine tailings mixture on at least one side, illustrative, non-exclusive examples of which include any suitable sloped (i.e., inclined) surface 408 and/or dyke, or berm, 410. Storage area 400 also may include, or define a mixing volume 300, in which the components of composite mine tailings mixture 310 are mixed together, such as in the configurations and/or with the methods disclosed herein. It is within the scope of the present disclosure to additionally or alternatively include at least one mixing volume 300 that is not within the storage area and/or to not utilize a defined mixing volume. The mixing may be of two or more components of the composite mine tailings mixture, but it also is within the scope of the present disclosure that the composite mine tailings mixture may be mixed prior to being received in any mixing volume and/or storage area.

As shown in dash-dot lines in FIG. 1, storage area 400 may further include or be in contact with a dewatering system 500 that may collect fluid 330, such as water 322, that separates from the composite mine tailings mixture and remove this collected water as released water 404. The flow of removed water may be referred to as a removed water stream 406. Dewatering system 500 may include any suitable structure adapted to collect and/or remove water from the composite mine tailings mixture, illustrative, non-exclusive examples of which include sand 412, pipes 502, gravel 504, a French drain 506, a sand column 414, and/or a rim ditch 508. It is within the scope of the present disclosure that dewatering system 500 may form a part of and/or be contained within storage area 400, as shown by the schematically illustrated overlap between the dewatering system and the storage area in the illustrative, non-exclusive example of FIG. 1. However, it is also within the scope of the present disclosure that dewatering system 500 may be separate from storage area 400.

It is also within the scope of the present disclosure that dewatering system 500 may include one or more earth-moving devices that are adapted to agitate or disturb at least a portion of the composite mine tailings mixture. As illustrative, non-exclusive examples, the earth-moving device may turn, rototill, aerate, disk, plow, and/or trench at least a portion of the composite mine tailings mixture. Use of the earth-moving device may promote or increase the dewatering rate by providing flow channels for water drainage, exposing moisture-laden portions of the composite mine tailings mixture to the atmosphere to promote evaporation, and/or increasing a surface area over which evaporation may occur. The earth-moving device may be configured to agitate or disturb any suitable portion of the composite mine tailings mixture. As an illustrative, non-exclusive example, this may include disturbing an entire surface area of the composite mine tailings mixture, disturbing a specific portion of the composite mine tailings mixture, disturbing a portion of the composite mine tailings mixture that includes a highest water content, and/or disturbing a perimeter of the composite mine tailings mixture. As another illustrative, non-exclusive example, the earth-moving device may create one or more trenches at or near an outer perimeter of the storage area.

It is within the scope of the present disclosure that composite mine tailings mixture 310 may be formed using any suitable mechanism and may include an as-formed water content. After formation of the composite mine tailings mixture, and as discussed in more detail herein, the composite mine tailings mixture may be placed within a storage area and/or a dewatering area, where the water content of the composite mine tailings mixture may decrease with time as released water 406 is removed from the composite mine tailings mixture. It is within the scope of the present disclosure that the as-formed water content of the composite mine tailings mixture may be less than 70 wt %, including as-formed water contents of less than 65 wt %, less than 60 wt %, less than 55 wt %, less than 50 wt %, less than 45 wt %, less than 40 wt %, or less than 35 wt %.

FIG. 2 is a somewhat less schematic, but still illustrative, non-exclusive example, of a composite mine tailings mixture 310 contained within a storage area 400 including a dewatering system 500 that may form a part of a mine tailings treatment system 10 according to the present disclosure. In the illustrative example of FIG. 2, storage area 400 includes a dyke 410 that may be constructed of any suitable material(s), illustrative, non-exclusive examples of which include sand 412 and/or gravel 504. Composite mine tailings stream 315 enters the storage area and may flow down a sloped surface 408. Flow down sloped surface 408 may lead to the settling of solids from the composite mine tailings mixture and the formation of released water 404 and/or released water stream 406. It is within the scope of the present disclosure that a portion of the released water may collect within storage area 400 as shown. Additionally or alternatively, it is within the scope of the present disclosure that a portion of the released water may exit storage area 400 as the released water stream and be collected and removed by dewatering system 500.

As discussed in more detail herein, dewatering system 500 may include any suitable structure adapted to facilitate the removal of water from composite mine tailings mixture 310. An illustrative, non-exclusive example of dewatering system 500 includes sloped surface 408. Another illustrative, non-exclusive example of dewatering system 500 according to the present disclosure includes sand column 414, which may include sand 412 and may form a sink for released water stream 406. Another illustrative, non-exclusive example of dewatering system 500 according to the present disclosure includes French drain 506. French drain 506 may include sand 412, gravel 504, and/or drainage pipe 502 and may serve as a hydraulic pathway to convey released water 404 from composite mine tailings mixture 310 and/or storage area 400.

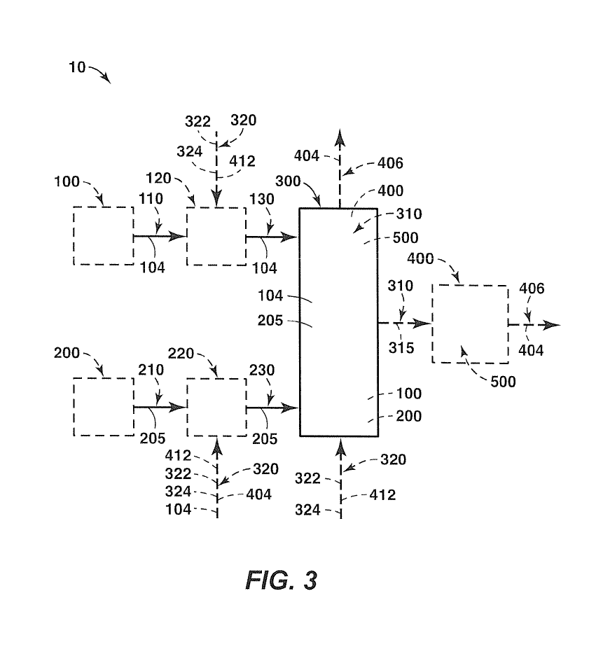

The composite mine tailings mixture of FIGS. 1 and 2 may be produced using any suitable method, mechanism, and/or system. FIG. 3 provides a schematic representation of illustrative, non-exclusive examples of mine tailings treatment systems 10 according to the present disclosure that may be utilized to produce composite mine tailings mixture 310. Mine tailings treatment system 10, which additionally or alternatively may be referred to as, and/or as including mine tailings treatment apparatus 10, mine tailings treatment equipment 10, and/or mine tailings treatment hardware 10, includes mixing volume 300 that may receive and/or contain mine tailings 104 and wicking fibers 205 and produce composite mine tailings mixture 310 therefrom.

It is within the scope of the present disclosure that mine tailings 104 may be supplied and/or obtained from any suitable source. As an illustrative, non-exclusive example, mixing volume 300 may include or contain mine tailings 104, such as when mixing volume 300 includes storage area 400 and/or mine tailings source 100. Thus, the mine tailings may already be present within the mixing volume, and the mixing volume may receive wicking fibers 205 to produce the composite mine tailings mixture.

As another illustrative, non-exclusive example, mine tailings treatment system 10 may include and/or be in communication with a mine tailings source 100; and a mine tailings delivery system 120 may receive and/or convey mine tailings 104, as mine tailings supply stream 110, from mine tailings source 100. Mine tailings delivery system 120 also may optionally receive one or more supplemental stream(s) 320 and may supply the received supplemental stream(s), together with the mine tailings, to mixing volume 300 as mine tailings feed stream 130. As discussed in more detail herein, supplemental stream(s) 320 may include any suitable supplemental stream, including water 322, chemical reagent 324, and/or sand 412.

It is also within the scope of the present disclosure that mine tailings source 100 includes a settling pond adapted to separate a portion of the solids present within the mine tailings from a portion of the liquid present therein. When the mine tailings source includes a settling pond, a dredging device may be utilized to remove mine tailings from the settling pond as dredged mine tailings, which also may be referred to as mature fine tailings, and the mine tailings supplied to the mixing volume may include the dredged mine tailings.

Similarly, it is within the scope of the present disclosure that wicking fibers 205 may be supplied and/or obtained from any suitable source. As an illustrative, non-exclusive example, mixing volume 300 may include or contain wicking fibers 205, such as when mixing volume 300 includes a wicking fiber source 200. Thus, the wicking fibers may already be present within the mixing volume and the mixing volume may receive mine tailings 104 to produce the composite mine tailings mixture.

As another illustrative, non-exclusive example, mine tailings treatment system 10 may include or be in communication with wicking fiber source 200, and a wicking fiber delivery system 220 may receive and/or convey wicking fibers 205, as wicking fiber supply stream 210, from wicking fiber source 200. Wicking fiber delivery system 220 also may optionally receive one or more supplemental stream(s) 320 and may supply the received supplemental stream(s), together with the wicking fibers, to mixing volume 300 as wicking fiber feed stream 230. As discussed in more detail herein, supplemental stream(s) 320 may include any suitable supplemental stream, including water 322, chemical reagent 324, and/or sand 412.

It is within the scope of the present disclosure that, when wicking fibers 205 are supplied as wicking fiber feed stream 230, the wicking fiber stream may include a dry, or nominally dry, stream of wicking fibers, including a stream of wicking fibers that is dried prior to delivery to the mixing volume. However, it is also within the scope of the present disclosure that the wicking fibers may be mixed with a fluid to form a slurry of wicking fibers and that the wicking fiber feed stream may include the slurry of wicking fibers. When the wicking fibers are mixed with a fluid, the fluid may include any suitable fluid, illustrative, non-exclusive examples of which include water 322, released water 404, and/or a portion of mine tailings 104.

Mixing volume 300 also may receive one or more supplemental streams 320, which may be combined with mine tailings 104, mine tailings feed stream 130, wicking fibers 205, and or wicking fiber feed stream 230 therein to produce the composite mine tailings mixture. Supplemental stream 320 may include any suitable material, illustrative, non-exclusive examples of which include water 322, chemical reagent 324, and/or sand 412. Chemical reagent 324 may include any suitable binder, coagulant, and/or flocculent, including the binders, coagulants, and flocculants discussed in more detail herein.

Mixing volume 300 may include any suitable volume or structure that is adapted to combine the streams and/or materials supplied thereto and produce composite mine tailings mixture 310. As an illustrative, non-exclusive example, mixing volume 300 may include a containment structure. As another illustrative, non-exclusive example, mixing volume 300 may include any suitable sloped or flat surface adapted to support the mine tailings, wicking fibers, and/or the composite mine tailings mixture. As yet another illustrative, non-exclusive example, mixing volume 300 may include a static mixer, a stirred tank, and/or an auger that is adapted to mix the components of composite mine tailings mixture 310. Additionally or alternatively, mixing volume 300 may include a fiber injector that may inject at least a portion of the wicking fibers into the mine tailings to form the composite mine tailings mixture.

It is within the scope of the present disclosure that mixing volume 300 may include and/or form a portion of storage area 400 and/or dewatering system 500. When mixing volume 300 includes storage area 400 and dewatering system 500, it also may be referred to as a dewatering area. Additionally or alternatively, it is within the scope of the present disclosure that composite mine tailings mixture 310 may be delivered, such as via a composite mine tailings mixture stream 315, to a separate storage area 400 that may include dewatering system 500. When mine tailings treatment system 10 includes dewatering system 500, the mine tailings treatment system may remove released water 406, such as by released water stream 404, from composite mine tailings mixture 310.

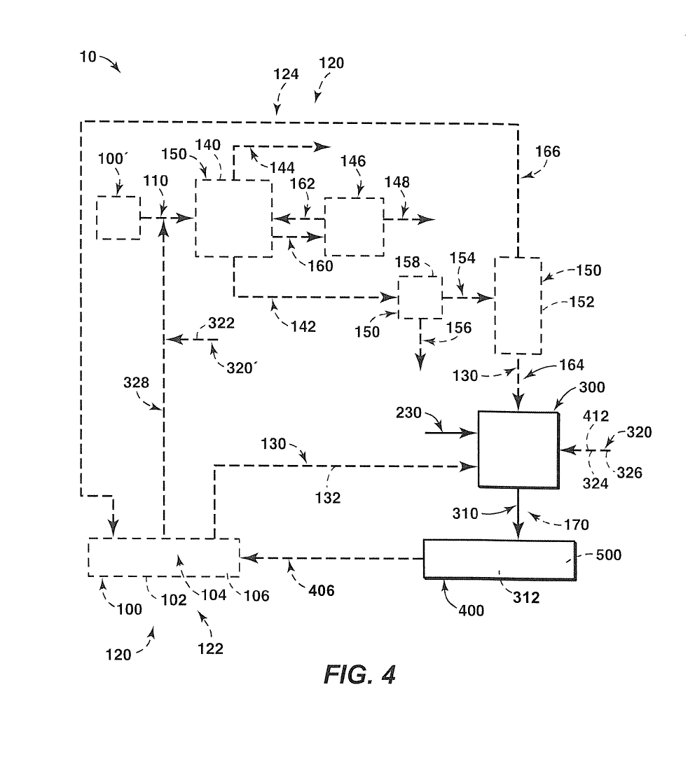

FIG. 4 provides less schematic, but still illustrative, non-exclusive examples of a mine tailings treatment system 10 according to the present disclosure. The mine tailings treatment system of FIG. 4 is an integrated mine tailings treatment system that optionally includes two mine tailings delivery systems 120, namely, aged tailings delivery system 122 and raw tailings delivery system 124. Both aged tailings delivery system 122 and raw tailings delivery system 124 supply mine tailings feed stream 130 to mixing volume 300, which also may receive wicking fiber feed stream 230 and optional supplemental stream 320. As discussed in more detail herein, supplemental stream 320 may include any suitable supplemental stream, including chemical reagent 324, such as binder 326, and/or sand 412. Mixing volume 300 combines the supplied streams to produce composite mine tailings mixture 310, which may be supplied to storage area 400. The composite mine tailings mixture may be dewatered by dewatering system 500 to produce a released water stream 406, which may be supplied to aged tailings delivery system 122, such as to settling pond 102. The composite mine tailings mixture 310 supplied to the storage 400 may be deposited in the storage area in any suitable manner as a composite mine tailings deposit 312. The composite mine tailings deposit 312 and various manners of depositing the composite mine tailings mixture is explained in further detail elsewhere herein.

Aged tailings delivery system 122 includes a mine tailings source 100, such as settling pond 102 that contains mine tailings 104. If the mine tailings are aged within the settling pond for a sufficient densifying time, the settling pond may additionally or alternatively contain mature fine tailings 106. Aged tailings delivery system 122 may supply mine tailings feed stream 130, such as mature fine tailings stream 132 to mixing volume 300. In addition, fluid, such as water, that separates from the mine tailings within settling pond 102 may be discharged from the settling pond as recycled water 328, which may be mixed with supplemental stream 320′, including water 322, before being supplied to raw mine tailings delivery system 124.

Raw tailings delivery system 124 includes a mine tailings source 100′ that may supply mine tailings supply stream 110 including mine tailings, water, and residual hydrocarbon, such as oil, to a separation device 150, such as primary separation vessel 140. The primary separation vessel may separate the mine tailings supply stream into a primary separation vessel tailings stream 142, a froth stream 144, and an oil-rich stream 160. The primary separation vessel tailings stream may include a substantial portion of the solids, together with a smaller portion of the water and residual oil present within the mine tailings supply stream. The oil-rich stream may include a substantial portion of the oil present in the mine tailings supply stream. The froth stream may include a portion of the fluids other than oil contained within the mine tailings supply stream, together with residual oil and residual solids, and may be discharged from the system.

Oil-rich stream 160 may be supplied to flotation cell 146, which may separate the oil-rich stream into a recovered oil stream 148, which may be utilized outside the mine tailings treatment system, and a recycle stream 162, which may be returned to the primary separation vessel. The primary separation vessel tailings stream may be supplied to a separation device 150, such as one or more screens 158, which may separate the primary separation vessel tailings stream into at least a fines stream 154 and a rejects stream 156. Rejects stream 156 may include a substantial portion of the large particulate matter contained within the primary separation vessel tailings stream and may discharge the large particulate matter from the mine tailings treatment system. As an illustrative, non-exclusive example, rejects stream 156 may contain or include particulate matter that is too large to pass through screen 158.

Fines stream 154 may contain fine particles, such as particles that may pass through screen 158, and may be supplied to another separation device 150, such as cyclone separator 152. Cyclone separator 152 may separate the product stream into an underflow stream 164, which may be supplied to mixing volume 300, and an overflow stream 166, which may be supplied to settling pond 102. The use of the mine tailings treatment system of FIG. 4 may provide for the creation of composite mine tailings mixture 310 from a variety of mine tailings sources. These sources may include aged mine tailings, such as mature fine tailings, as well as raw forms of mine tailings, such as fluid fine tailings and/or thin fine tailings, as discussed in more detail herein.

It is within the scope of the present disclosure that mine tailings treatment system 10 may include any suitable collection of pipes, pumps, conveyors, belts, valves, control systems, tanks, conveyance vehicles, and the like that may be utilized to control a flow of the various streams associated therewith to the various components of the mine tailings treatment system. This may include manual and/or automated control of the stream flows. As an illustrative, non-exclusive example, mine tailings treatment system 10 may further include a composite mine tailings mixture delivery system 170 that may deliver the composite mine tailings mixture from the mixing volume to the storage volume.

As discussed in more detail herein, FIG. 4 provides illustrative, non-exclusive examples of a mine tailings treatment system 10 according to the present disclosure. Thus, the structure presented in FIG. 4 may vary without departing from the scope of the present disclosure. As an illustrative, non-exclusive example, released water stream 406 may be supplied directly to raw tailings delivery system 124 without first being supplied to settling pond 102. As another illustrative, non-exclusive example, released water, recycled water 328, and/or water 322 may be combined with wicking fiber feed stream 230 to form a slurry of wicking fibers prior to delivery to the mixing volume. As yet another illustrative, non-exclusive example, it is within the scope of the present disclosure that, as discussed in more detail herein, mixing volume 300, storage area 400, and/or dewatering system 500 may be separate and distinct from one another. However, it is also within the scope of the present disclosure that mixing volume 300 may include storage area 400 and/or dewatering system 500. It is also within the scope of the present disclosure that supplemental stream 320 may be supplied to any suitable location within the mine tailings treatment system, illustrative, non-exclusive examples of which include separation devices 150, flotation cell 146, mine tailings sources 100, storage area 400, and/or dewatering system 500. It is further within the scope of the present disclosure that mine tailings treatment system 10 may include only aged tailings delivery system 122, only raw tailings delivery system 124, and/or that the mine tailings treatment system may include another mine tailings delivery system 120 in addition to those illustrated in FIG. 4.

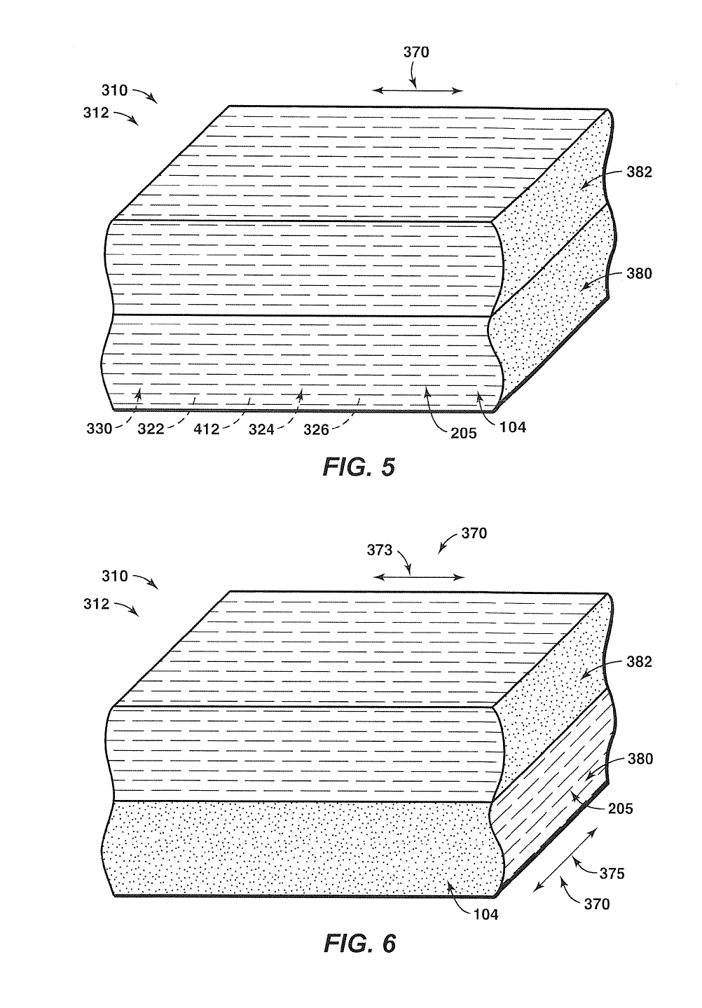

The systems and methods disclosed herein may include the use of mine tailings treatment system 10 to create a composite mine tailings mixture deposit 312 that includes composite mine tailings mixture 310 and may include any suitable orientation and/or structure, both of the composite mine tailings mixture itself and of the wicking fibers contained within the composite mine tailings mixture. This is shown schematically in FIGS. 5-8. In each of FIGS. 5-8, the composite mine tailings mixture deposit includes wicking fibers 205 distributed within mine tailings 104. The composite mine tailings mixture deposits of FIGS. 5-8 also may include chemical reagent 324, such as binding agent 326, sand 412, and/or fluid 330, such as water 322.

In FIG. 5, composite mine tailings mixture 310 is shown to include a lower layer 380 and an upper layer 382. A portion of the plurality of wicking fibers in lower layer 380 and/or upper layer 382 may be aligned along a primary wicking direction 370, which additionally or alternatively may be referred to as a predominant wicking direction 370. In FIG. 5, the primary wicking direction for lower layer 380 and the primary wicking direction for upper layer 382 are aligned and/or oriented in a substantially similar and/or substantially parallel direction. However, it is also within the scope of the present disclosure that the primary wicking direction for one layer, such as lower layer 380, may differ from the primary wicking direction of another layer, such as upper layer 382.

As used herein, orienting the wicking fibers in a substantially similar primary wicking direction may include orienting an axis of at least a portion of the plurality of wicking fibers along the primary wicking direction. As an illustrative, non-exclusive example, a portion of the plurality of wicking fibers may include a longitudinal axis that is oriented along the primary wicking direction. As another illustrative, non-exclusive example, a portion of the plurality of wicking fibers may include a longitudinal axis that is oriented to be within a threshold angle of the primary wicking direction, illustrative, non-exclusive examples of which include threshold angles of less than 30 degrees, less than 25 degrees, less than 20 degrees, less than 15 degrees, less than 10 degrees, or less than 5 degrees.

Illustrative, non-exclusive examples of the portion of the plurality of wicking fibers include some of the plurality of wicking fibers, such as 10-30% of the wicking fibers, a substantial portion of the plurality of wicking fibers, such as 30-50% of the wicking fibers, or a majority of the plurality of wicking fibers, such as more than 50% of the wicking fibers. It is within the scope of the present disclosure that the deposit of FIG. 5 may additionally or alternatively include three or more layers.

FIG. 6 is substantially similar to FIG. 5 and includes a composite mine tailings mixture deposit 312 that includes lower layer 380 and upper layer 382. However, in FIG. 6, a primary wicking direction of the wicking fibers in the upper layer 373 is different from a primary wicking direction of the wicking fibers in the lower layer 375. It is within the scope of the present disclosure that the primary wicking direction of the wicking fibers in the upper layer and the primary wicking direction of the wicking fibers in the lower layer may include any suitable relative orientation. As an illustrative, non-exclusive example, it is within the scope of the present disclosure that the primary wicking direction of the wicking fibers in the upper layer is substantially perpendicular to the primary wicking direction of the wicking fibers in the lower layer. As another illustrative, non-exclusive example, it is within the scope of the present disclosure that the primary wicking direction of the wicking fibers in the upper layer may form an acute or obtuse angle with the primary wicking direction of the wicking fibers in the lower layer. It is also within the scope of the present disclosure that the deposit may include three or more layers and that each layer may include wicking fibers that are oriented in a predominant wicking direction that is different than the predominant wicking direction of the other layers and/or of the adjacent layer(s).

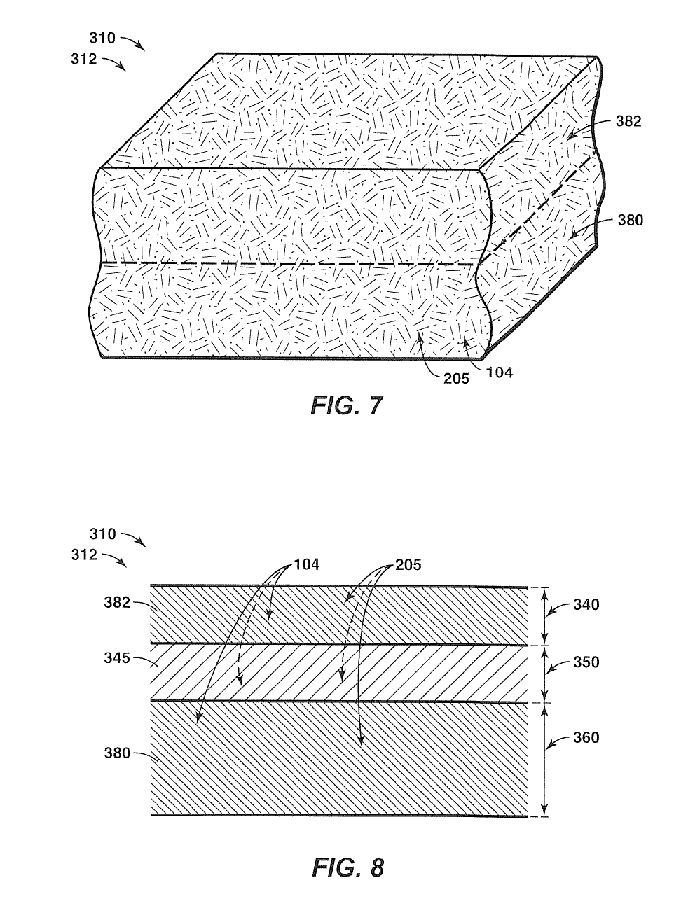

It is also within the scope of the present disclosure that the composite mine tailings mixture deposit may not include any predominant long-range orientation and/or structure therein. This is schematically illustrated in FIG. 7, which illustrates composite mine tailings mixture deposit 312 including a random orientation of wicking fibers. As shown in dashed lines, it is within the scope of the present disclosure that the composite mine tailings mixture deposit of FIG. 7 may include lower layer 380 and upper layer 382; however, it is also within the scope of the present disclosure that the composite mine tailings mixture may not include layers and/or that it may include more than two such layers.

As discussed, it is within the scope of the present disclosure that composite mine tailings mixture deposit 312 also may include a plurality of layers, including three or more layers, that a thickness of the layers may vary from one layer to the next, and/or that a density of wicking fibers within the layers may vary from one layer to the next. This is shown schematically in FIG. 8. In FIG. 8, composite mine tailings mixture deposit 312 is illustrated including three layers, lower layer 380, an intermediate layer 345, and upper layer 382. Lower layer 380 includes a lower layer thickness 360, intermediate layer 345 includes an intermediate layer thickness 350, and upper layer 382 includes an upper layer thickness 340.

It is within the scope of the present disclosure that any suitable relationship may exist among the layer thicknesses. As an illustrative, non-exclusive example, it is within the scope of the present disclosure that each of the layers 380, 345, and 382 may include substantially similar layer thicknesses 360, 350, and 340, respectively. As another illustrative, non-exclusive example, it is within the scope of the present disclosure that at least a first portion of the plurality of layers may include a substantially different thickness than at least a second portion of the plurality of layers, illustrative, non-exclusive examples of which include at least a first portion of the plurality of layers including a layer thickness that is at least twice, at least three times, at least five times, at least 10 times, at least 12 times, at least 15 times, at least 20 times, at least 25 times, at least 30 times, or at least 50 times the thickness of the second portion of the plurality of layers. As another illustrative, non-exclusive example, it is within the scope of the present disclosure that intermediate layer thickness 350 may be greater than at least one of upper layer thickness 340 and lower layer thickness 360, including the illustrative layer thickness ratios disclosed above.

It is also within the scope of the present disclosure that the composition of at least one of the lower layer, the intermediate layer, and the upper layer may be substantially different from the composition of one or more of the other of the layers. This is shown schematically in FIG. 8 by the variation in pattern density between the intermediate layer and the upper and lower layers. As an illustrative, non-exclusive example, it is within the scope of the present disclosure that the intermediate layer may include a lower concentration of wicking fibers than at least one of the upper layer and the lower layer. As another illustrative, non-exclusive example, it is within the scope of the present disclosure that the intermediate layer may not include wicking fibers. As another illustrative, non-exclusive example, it is within the scope of the present disclosure that the intermediate layer may include a greater concentration of wicking fibers than at least one of the upper layer and the lower layer. As another illustrative, non-exclusive example, it is within the scope of the present disclosure that each of the plurality of layers may include a different fiber concentration. As another illustrative, non-exclusive example, it is within the scope of the present disclosure that each of the lower layer, the intermediate layer, and the upper layer may contain mine tailings. However, it is also within the scope of the present disclosure that at least one of the lower layer, the intermediate layer, and the upper layer may not contain mine tailings or may contain a substantially different concentration of mine tailings than at least one of the other layers.

As discussed in more detail herein, FIGS. 5-8 provide illustrative, non-exclusive examples of composite mine tailings deposits according to the present disclosure. It is within the scope of the present disclosure that composite mine tailings deposit 312 may include any suitable number of layers, including one layer, two layers, three layers, four layers, five layers, ten layers, or more than ten layers. It is also within the scope of the present disclosure that, as discussed in more detail herein, each of the plurality of layers may include any suitable layer thickness and that any suitable relationship may exist among the various layer thicknesses.

When the wicking fibers are oriented along a predominant wicking direction, it is within the scope of the present disclosure that this orientation may be accomplished using any suitable system and/or method. As an illustrative, non-exclusive example, the composite mine tailings mixture deposit may be formed by flowing the composite mine tailings mixture in a flow direction, and the flowing may induce an overall orientation of the wicking fibers along the flow direction.

Similarly, layers present within the composite mine tailings mixture deposit may be formed in any suitable manner. As an illustrative, non-exclusive example, the layers may be formed by flowing the composite mine tailings mixture across a surface and optionally allowing the composite mine tailings mixture to dry or otherwise age before covering it with a subsequent layer. As another illustrative, non-exclusive example, the layers may be formed by spreading the wicking fibers on the mine tailings. As another illustrative, non-exclusive example, the layers may be formed by spreading the mine tailings on the wicking fibers. The spreading may additionally or alternatively include orienting at least a portion of the plurality of wicking fibers along the wicking direction.

Providing wicking fibers within the composite mine tailings mixture deposit, orienting at least a portion of the wicking fibers within the composite mine tailings mixture deposit, and/or providing other structure to the composite mine tailings mixture deposit, such as layers, may improve the physical and/or hydraulic characteristics of the composite mine tailings mixture deposit. As illustrative, non-exclusive examples, composite mine tailings mixture deposits according to the present disclosure may exhibit a greater dewatering rate, a greater fluid permeability, and increased mechanical strength, and/or an increased shear strength in the as-formed composite mine tailings mixture deposit and/or after the composite mine tailings mixture deposit has released water for a dewatering time when compared to a mine tailings deposit that does not include the plurality of wicking fibers.

As an illustrative, non-exclusive example, it is within the scope of the present disclosure that, after a dewatering time of one year, a shear strength of the composite mine tailings mixture deposit is at least 5 kPa, including shear strengths of at least 6 kPa, at least 7 kPa, at least 8 kPa, at least 9 kPa, or at least 10 kPa after a dewatering time of one year. As another illustrative, non-exclusive example, it is within the scope of the present disclosure that, after a dewatering time of five years, the shear strength of the composite mine tailings mixture deposit is at least 10 kPa, including shear strengths of at least 12 kPa, at least 14 kPa, at least 16 kPa, at least 18 kPa, or at least 20 kPa after a dewatering time of five years.

When the composite mine tailings mixture deposit includes a plurality of layers, it is within the scope of the present disclosure that at least a portion of the plurality of layers may be in fluid communication with one another. However, it is also within the scope of the present disclosure that at least a portion of the plurality of layers may not be in fluid communication with one another.

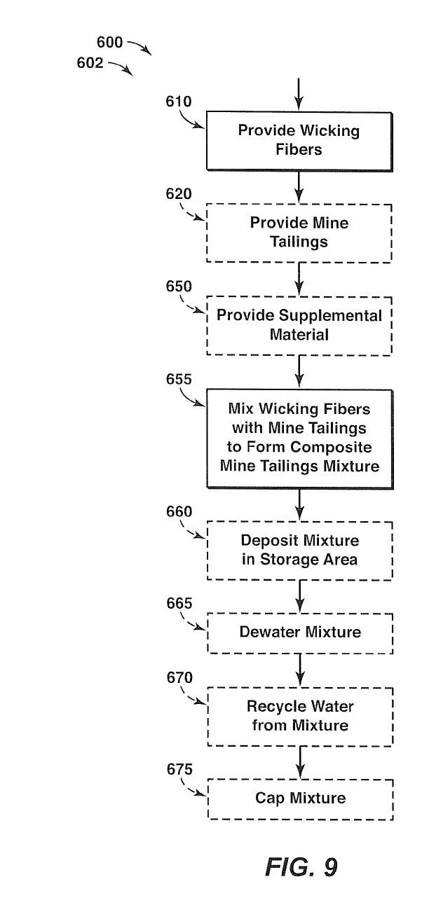

As discussed in more detail herein, the systems and compositions disclosed herein may be utilized with any suitable method. FIG. 9 is a flowchart depicting an illustrative, non-exclusive example of methods 600 of producing composite mine tailings mixture and/or composite mine tailings mixture deposit according to the present disclosure. Methods 600 also may be referred to as methods 602 of dewatering mine tailings. The methods include providing wicking fibers at 610 and mixing the wicking fibers with mine tailings to form the composite mine tailings mixture at 655. The methods may include one or more additional steps, or portions, illustrative, non-exclusive examples of which are indicated in dashed boxes in FIG. 9.

It is within the scope of the present disclosure that methods 600 also may include providing mine tailings at 620 and/or providing supplemental materials at 650, such as may be provided by supplemental stream 320 of FIGS. 3-4. Providing mine tailings at 620 may include providing the mine tailings from any suitable source, including those sources discussed in more detail herein.

Providing supplemental materials at 650 may include providing any suitable supplemental material including water 322, sand 412, chemical reagent 324, and/or binding agent 326, illustrative, non-exclusive examples of which are discussed in more detail herein with reference to FIGS. 3-4. When the supplemental material includes binding agent 326, the binding agent may be supplied to decrease a chemical stability of the colloidal suspension of fine particles contained within the mine tailings. As an illustrative, non-exclusive example, when binding agent 326 includes an acid, the acid may be added until a pH of the composite mine tailings mixture is less than 7.5, including a pH of less than 7, less than 6.5, or less than 6. As another illustrative, non-exclusive example, when binding agent 326 includes a base, the base may be added until the pH of the composite mine tailings mixture is greater than 10, including a pH of greater than 10.5 or greater than 11.

When supplemental materials 650 include sand, the sand may be added until the sand-to-fines ratio in the composite mine tailings mixture is between 0.3 and 8, including sand-to-fines ratios of between 0.5-7, between 0.8-5, between 1-3.5, or between 1-4. Additionally or alternatively, the sand may be added until the sand-to-fines ratio in the composite mine tailings mixture is less than 8, including sand-to-fines ratios of less than 7, less than 6, less than 5, less than 4, less than 3.5, less than 3, less than 2.5, less than 2, or less than 1.

Methods 600 also may include depositing the composite mine tailings mixture in a storage area as a composite mine tailings mixture deposit at 660, dewatering the composite mine tailings mixture at 665, recycling water from the composite mine tailings mixture at 670, and/or capping the composite mine tailings mixture and/or composite mine tailings mixture deposit at 675. Dewatering the composite mine tailings mixture at 665 may include removing at least a portion of the water present within the composite mine tailings mixture. It is within the scope of the present disclosure that the removed water may be captured for future use or discharged from the mine tailings treatment system. When the removed water is captured for future use, it is within the scope of the present disclosure that the captured water may be recycled within the mine tailings treatment system. Illustrative, non-exclusive examples of recycling the captured water include utilizing the captured water within the mine tailings treatment system as described in detail herein with reference to FIG. 4 and/or recycling the captured water to a mining facility. When the captured water is recycled to the mining facility, the captured water may be utilized in a mining process, which may include the use of the captured water to generate additional mine tailings.

It is also within the scope of the present disclosure that the captured water may be treated prior to, during, and/or after being recycled. This may include chemically treating the captured water, such as to change a pH, ionic strength, or other chemical concentration and/or to remove undesirable components from the captured water and/or mechanically treating the captured water, such as filtering to remove particulates.

Capping the composite mine tailings mixture and/or the composite mine tailings mixture deposit at step 675 may include covering the mine tailings with a capping material. Illustrative, non-exclusive examples of capping materials according to the present disclosure include coke, sand, and mine overburden that was removed from the mine site prior to and/or during the mining process.

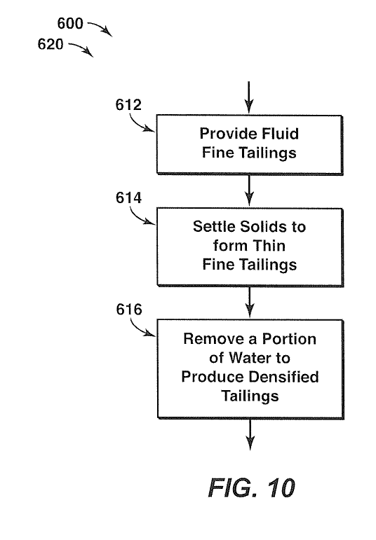

FIG. 10 is a flowchart depicting an illustrative, non-exclusive example of a method 620 of providing mine tailings. Method 620 includes providing fluid fine tailings at 612, settling solids from the fluid fine tailings to form thin fine tailings at 614, and removing a portion of the water present in the thin fine tailings to produce densified tailings at 616.

Removing a portion of the water present in the thin fine tailings to produce densified tailings at 616 may include placing the thin fine tailings in a settling pond for a densifying time to produce mature fine tailings. Additionally or alternatively, removing a portion of the water present in the thin fine tailings to produce densified tailings at 616 may include adding a flocculent to the thin fine tailings to flocculate at least a portion of the particles present within the thin fine tailings and produce thickened tailings.

As discussed in more detail herein, it is within the scope of the present disclosure that the systems and methods disclosed herein may be utilized to treat mine tailings. These mine tailings may be produced by any suitable mining operation, illustrative, non-exclusive examples of which include mining operations that produce oil, such as mining operations that recover oil from an oil sands deposit. When the mine tailings are produced by a mining operation that produces oil, it is within the scope of the present disclosure that the mine tailings may further include a hydrocarbon, such as oil.

In the present disclosure, several of the illustrative, non-exclusive examples have been discussed and/or presented in the context of flow diagrams, or flow charts, in which the methods are shown and described as a series of blocks, or steps. Unless specifically set forth in the accompanying description, it is within the scope of the present disclosure that the order of the blocks may vary from the illustrated order in the flow diagram, including with two or more of the blocks (or steps) occurring in a different order and/or concurrently. It is also within the scope of the present disclosure that the blocks, or steps, may be implemented as logic, which also may be described as implementing the blocks, or steps, as logics. In some applications, the blocks, or steps, may represent expressions and/or actions to be performed by functionally equivalent circuits or other logic devices. The illustrated blocks may, but are not required to, represent executable instructions that cause a computer, processor, and/or other logic device to respond, to perform an action, to change states, to generate an output or display, and/or to make decisions.

As used herein, the term “and/or” placed between a first entity and a second entity means one of (1) the first entity, (2) the second entity, and (3) the first entity and the second entity. Multiple entities listed with “and/or” should be construed in the same manner, i.e., “one or more” of the entities so conjoined. Other entities may optionally be present other than the entities specifically identified by the “and/or” clause, whether related or unrelated to those entities specifically identified. Thus, as a non-limiting example, a reference to “A and/or B,” when used in conjunction with open-ended language such as “comprising” may refer, in one embodiment, to A only (optionally including entities other than B); in another embodiment, to B only (optionally including entities other than A); in yet another embodiment, to both A and B (optionally including other entities). These entities may refer to elements, actions, structures, steps, operations, values, and the like.

As used herein, the phrase “at least one,” in reference to a list of one or more entities should be understood to mean at least one entity selected from any one or more of the entity in the list of entities, but not necessarily including at least one of each and every entity specifically listed within the list of entities and not excluding any combinations of entities in the list of entities. This definition also allows that entities may optionally be present other than the entities specifically identified within the list of entities to which the phrase “at least one” refers, whether related or unrelated to those entities specifically identified. Thus, as a non-limiting example, “at least one of A and B” (or, equivalently, “at least one of A or B,” or, equivalently “at least one of A and/or B”) may refer, in one embodiment, to at least one, optionally including more than one, A, with no B present (and optionally including entities other than B); in another embodiment, to at least one, optionally including more than one, B, with no A present (and optionally including entities other than A); in yet another embodiment, to at least one, optionally including more than one, A, and at least one, optionally including more than one, B (and optionally including other entities). In other words, the phrases “at least one,” “one or more,” and “and/or” are open-ended expressions that are both conjunctive and disjunctive in operation. For example, each of the expressions “at least one of A, B and C,” “at least one of A, B, or C,” “one or more of A, B, and C,” “one or more of A, B, or C” and “A, B, and/or C” may mean A alone, B alone, C alone, A and B together, A and C together, B and C together, A, B and C together, and optionally any of the above in combination with at least one other entity.

In the event that any of the references that are incorporated by reference herein define a term in a manner or are otherwise inconsistent with either the non-incorporated portion of the present disclosure or with any of the other incorporated references, the non-incorporated portion of the present disclosure shall control, and the term or incorporated disclosure therein shall only control with respect to the reference in which the term is defined and/or the incorporated disclosure was originally present.

Illustrative, non-exclusive examples of systems and methods according to the present disclosure are presented in the following enumerated paragraphs. It is within the scope of the present disclosure that an individual step of a method recited herein, including in the following enumerated paragraphs, may additionally or alternatively be referred to as a “step for” performing the recited action.

A1. A method of increasing a rate of dewatering of mine tailings, the method comprising:

providing a plurality of wicking fibers; and

mixing at least a portion of the plurality of wicking fibers with mine tailings to form a composite mine tailings mixture.

A2. The method of paragraph A1, the method further including depositing the composite mine tailings mixture in a storage area as a composite mine tailings deposit.

A3. The method of paragraph A2, wherein depositing the composite mine tailings mixture in the storage area includes conveying at least a portion of the composite mine tailings mixture to the storage area on a conveyor.

A4. The method of any of paragraphs A2-A3, wherein depositing the composite mine tailings mixture in the storage area includes pumping at least a portion of the composite mine tailings mixture to the storage area.

A5. The method of any of paragraphs A2-A4, wherein depositing the composite mine tailings mixture in the storage area includes hauling at least a portion of the composite mine tailings mixture to the storage area, and optionally wherein the hauling includes hauling the composite mine tailings mixture in at least one of a rail car, a truck, a tanker truck, and a dump truck.

A6. The method of any of paragraphs A2-A5, wherein the storage area includes a temporary storage area, and the method further includes moving at least a portion of the composite mine tailings mixture to a dewatering area.

A7. The method of any of paragraphs A2-A6, wherein the storage area includes a dewatering area.

A8. The method of any of paragraphs A2-A7, wherein at least a portion of the plurality of wicking fibers within the composite mine tailings deposit is arranged randomly.

A9. The method of any of paragraphs A2-A8, wherein the composite mine tailings deposit includes a primary wicking direction, and further wherein the method includes orienting at least a portion of the plurality of wicking fibers in the primary wicking direction, optionally wherein the method includes orienting a substantial portion of the plurality of wicking fibers in the primary wicking direction, and further optionally wherein the method includes orienting a majority of the plurality of wicking fibers in the primary wicking direction.

A10. The method of any of paragraphs A2-A9, wherein the depositing includes flowing the composite mine tailings mixture in a depositing flow direction, and optionally wherein the method includes orienting at least a portion of the plurality of wicking fibers in the depositing flow direction, further optionally wherein the method includes orienting a substantial portion of the plurality of wicking fibers in the depositing flow direction, and further optionally wherein the method includes orienting a majority of the plurality of wicking fibers in the depositing flow direction.

A11. The method of any of paragraphs A1-A10, wherein the mixing includes flowing the composite mine tailings mixture in a mixing flow direction, and optionally wherein the method includes orienting at least a portion of the plurality of wicking fibers in the mixing flow direction, further optionally wherein the method includes orienting a substantial portion of the plurality of wicking fibers in the mixing flow direction, and further optionally wherein the method includes orienting a majority of the plurality of wicking fibers in the mixing flow direction.

A12. The method of any of paragraphs A2-A11, wherein the mixing includes mixing the portion of the plurality of wicking fibers with the mine tailings prior to depositing the composite mine tailings mixture in the storage area.

A13. The method of any of paragraphs A2-A12, wherein the mixing includes mixing the portion of the plurality of wicking fibers with the mine tailings concurrently with depositing the composite mine tailings mixture in the storage area.

A14. The method of any of paragraphs A2-A13, wherein the mixing includes mixing the portion of the plurality of wicking fibers with the mine tailings in the storage area.

A15. The method of any of paragraphs A1-A14, wherein the mixing includes arranging the plurality of wicking fibers in a plurality of layers within the composite mine tailings mixture.

A16.The method of any of paragraphs A1-A15, wherein the mixing includes injecting at least a portion of the plurality of wicking fibers into the portion of the mine tailings to form the composite mine tailings mixture.

A17. The method of any of paragraphs A1-A16, wherein the mixing includes spreading the portion of the plurality of wicking fibers on the mine tailings.

A18. The method of any of paragraphs A1-A17, wherein the mixing includes spreading a portion of the mine tailings on the portion of the plurality of wicking fibers.

A19.The method of any of paragraphs A1-A18, wherein the mixing includes flowing the mine tailings and the portion of the plurality of wicking fibers through a static mixer.

A20.The method of any of paragraphs A1-A19, wherein the mixing includes mixing the mine tailings and the portion of the plurality of wicking fibers in a stirred tank.

A21.The method of any of paragraphs A1-A20, wherein the mixing includes mixing the mine tailings and the portion of the plurality of wicking fiber using an auger.

A22.The method of any of paragraphs A2-A21, wherein the depositing includes depositing the composite mine tailings mixture in a plurality of layers, and optionally wherein depositing includes depositing the composite mine tailings mixture in a plurality of layers configured to increase a mechanical strength of the composite mine tailings deposit.

A23.The method of paragraph A22, wherein the plurality of layers are in fluid communication with one another, and the method optionally includes transferring a fluid among the plurality of layers.

A24.The method of any of paragraphs A22-A23, wherein the plurality of layers include at least a lower composite mine tailings mixture layer and an upper composite mine tailings mixture layer, wherein, in the lower composite mine tailings mixture layer, at least a portion of the plurality of wicking fibers are oriented in a lower layer direction, wherein, in the upper composite mine tailings mixture layer, at least a portion of the plurality of wicking fibers are oriented in an upper layer direction, and further wherein the depositing includes depositing the lower composite mine tailings mixture layer and depositing the upper composite mine tailings mixture layer, and optionally wherein at least one of the portion of the plurality of wicking fibers that are oriented in the lower layer direction and the portion of the plurality of wicking fibers that are oriented in the upper layer direction includes at least one of a substantial portion of the plurality of wicking fibers and a majority of the plurality of wicking fibers.

A25.The method of paragraph A24, wherein the lower layer direction is substantially similar to the upper layer direction.

A26.The method of paragraph A24, wherein the lower layer direction is different from the upper layer direction.

A27.The method of any of paragraphs A24-A26, wherein the lower composite mine tailings mixture layer and the upper composite mine tailings mixture layer are separated by an intermediate layer, and further wherein the depositing includes depositing the lower composite mine tailings mixture layer, depositing the intermediate layer, and depositing the upper composite mine tailings mixture layer.

A28.The method of paragraph A27, wherein the intermediate layer includes mine tailings.

A29.The method of any of paragraphs A27-A28, wherein the intermediate layer does not include the wicking fibers.

A30.The method of any of paragraphs A27-A28, wherein the intermediate layer includes a lower concentration of wicking fibers than the composite mine tailings mixture.

A31.The method of any of paragraphs A27-A28, wherein the intermediate layer includes a greater concentration of wicking fibers than the composite mine tailings mixture.

A32.The method of any of paragraphs A27-A31, wherein the intermediate layer includes an intermediate layer thickness and at least one of the upper composite mine tailings mixture layer and the lower composite mine tailings mixture layer includes a composite mine tailings mixture layer thickness, and further wherein the intermediate layer thickness is greater than the composite mine tailings mixture layer thickness, optionally including an intermediate layer thickness that is at least twice, at least three times, at least five times, at least 10 times, at least 12 times, at least 15 times, at least 20 times, at least 25 times, at least 30 times, or at least 50 times the composite mine tailings mixture layer thickness.

A33. The method of any of paragraphs A1-A32, the method further including dewatering the composite mine tailings mixture.

A34. The method of paragraph A33, wherein the dewatering includes removing water from the composite mine tailings mixture.

A35. The method of paragraph A34, wherein the method further includes capturing the removed water.

A36. The method of paragraph A35, wherein the method further includes recycling the captured water.

A37. The method of paragraph A36,wherein the recycling includes recycling the captured water to a mining facility.

A38. The method of any of paragraphs A35-A37, wherein the method further includes using the captured water in a mining process.

A39. The method of paragraph A38, wherein the method further includes producing mine tailings as a byproduct of the mining process.

A40. The method of any of paragraphs A35-A39, wherein the method further includes treating the captured water, and optionally wherein the treating includes treating the captured water prior to the recycling.

A41. The method of any of paragraphs A35-A39, wherein the method does not include treating the captured water, and optionally wherein the method does not include treating the captured water prior to using the captured water, and further optionally wherein the method does not include treating the captured water prior to using the captured water in a mining process.

A42. The method of any of paragraphs A40-A41, wherein the treating includes at least one of chemically treating, mechanically treating, and filtering.

A43. The method of any of paragraphs A33-A42, wherein the method further includes providing at least one of a sand layer and a sand column within at least one of the storage area and the dewatering area, and further wherein the dewatering includes flowing water from the composite mine tailings mixture through at least one of the sand layer and the sand column.

A44. The method of any of paragraphs A33-A43, wherein the method further includes utilizing an earth-moving technique to disturb the composite mine tailings mixture, and further wherein the dewatering includes at least one of draining and evaporating water from the composite mine tailings mixture.

A45. The method of paragraph A44, wherein the earth-moving technique includes at least one of turning, rototilling, aerating, disking, plowing, digging, and trenching.

A46. The method of any of paragraphs A33-A45, wherein the method further includes providing a trench for water drainage, and further wherein the dewatering includes draining water through the trench.

A47. The method of paragraph A46, wherein the providing the trench includes constructing the trench near an outer perimeter of at least one of the storage area and the dewatering area.

A48. The method of any of paragraphs A33-A47, wherein the dewatering includes the use of at least one of a dyke, rim ditching, wicking, a French drain, and a drain pipe.

A49. The method of any of paragraphs A33-A48, wherein at least one of the storage area and the dewatering area includes a sloped region, and further wherein the dewatering includes gravitational draining of water down the sloped region.

A50. The method of paragraph A1-A49, wherein the mine tailings include water, and further wherein the mine tailings optionally include at least one of sand, fine particles, clay particles, and colloidal clay particles.

A51. The method of paragraph A50, wherein the fine particles include a fine particle characteristic diameter, and further wherein the fine particle characteristic diameter is less than 60 micrometers, optionally including fine particle characteristic diameters of less than 55, less than 50, less than 45, less than 44, less than 40, or less than 35 micrometers.

A52. The method of any of paragraphs A1-A51, wherein the mine tailings include 5-60 wt % solids in water, optionally including 5-20 wt %, 6-14 wt %, 20-40 wt %, 40-60 wt %, 25-35 wt %, 45-55 wt %, approximately 10 wt %, approximately 15 wt %, approximately 20 wt %, approximately 25 wt %, approximately 30 wt %, approximately 35 wt %, approximately 40 wt %, approximately 45 wt %, approximately 50 wt %, or approximately 55 wt % solids in water.

A53. The method of any of paragraphs A 1-A52, wherein the mine tailings include at least one of fluid fine tailings, thin fine tailings, thickened tailings, mature fine tailings, and composite tailings.

A54. The method of any of paragraphs A1-A53, wherein a pH of the mine tailings is between 8 and 9, optionally including a pH of 8.1-8.8, 8.2-8.7, 8.3-8.5, approximately 8.3, approximately 8.4, or approximately 8.5.

A55. The method of any of paragraphs A1-A54, wherein the method further includes dredging the mine tailings from a pond.

A56. The method of any of paragraphs A1-A55, wherein the method further includes providing the mine tailings, and optionally wherein providing the mine tailings includes providing a mine tailings stream.

A57. The method of paragraph A56, wherein providing the mine tailings includes providing fluid fine tailings, settling solids from the fluid fine tailings to produce thin fine tailings, and removing a portion of the water present in the thin fine tailings to produce densified tailings; and further wherein mixing at least a portion of the plurality of wicking fibers with the mine tailings includes mixing the densified tailings with the portion of the plurality of wicking fibers.

A58. The method of paragraph A57, wherein removing a portion of the water present in the thin fine tailings includes gravitational settling and dewatering of the thin fine tailings for a densifying time to produce mature fine tailings, and further wherein mixing the densified tailings with the portion of the plurality of wicking fibers includes mixing the mature fine tailings with the portion of the plurality of wicking fibers.

A59. The method of paragraph A58, wherein the densifying time is greater than 6 months, optionally including densifying times of greater than 9 months, greater than 12 months, greater than 15 months, greater than 18 months, greater than 21 months, greater than 24 months, greater than 30 months, or greater than 36 months, and further optionally including densifying times of 6 months to 24 months, 9 months to 18 months, or 12 months to 24 months.

A60. The method of any of paragraphs A57-A59, wherein removing a portion of the water present in the thin fine tailings includes adding a flocculent to the thin fine tailings to flocculate at least a portion of the particles present within the thin fine tailings and produce thickened tailings, and further wherein mixing the densified tailings with the plurality of wicking fibers includes mixing the thickened tailings with the portion of the plurality of wicking fibers.

A61. The method of paragraph A60, wherein the flocculent includes at least one of a long-chain polymer flocculent, gypsum, an acid, a base, a multivalent cation, alum, aluminum chlorohydrate, aluminum sulfate, calcium oxide, calcium hydroxide, iron(II) sulfate, iron(III) chloride, polyacrylamide, polydiallyldimethylammonium chloride, sodium aluminate, sodium silicate, chitosan, isinglass, moringa oleifera seeds, gelatin, strychnos, guar gum, and alginates.

A62. The method of any of paragraphs A57-A61, wherein the thin fine tailings include approximately 4-20 wt % solids in water, optionally including 5-17 wt %, 6-14 wt %, 6-9 wt %, 10-14 wt %, or 8-12 wt % solids in water.

A63. The method of any of paragraphs A57-A62, wherein the densified tailings include approximately 20-40 wt % solids in water, optionally including 22-37 wt %, 25-35 wt %, 25-30 wt %, 30-35 wt %, or 28-33 wt % solids in water.

A64. The method of any of paragraphs A1-A63, wherein the method further includes separating at least a portion of the mine tailings into an underflow stream and an overflow stream in a cyclone separator, and further wherein mixing at least a portion of the mine tailings with the portion of the plurality of wicking fibers includes mixing at least a portion of the underflow stream with the portion of the plurality of wicking fibers.

A65. The method of any of paragraphs A1-A64, wherein the method further includes adding at least one binding agent to at least one of the mine tailings, the portion of the plurality of wicking fibers, and the composite mine tailings mixture, and optionally wherein the composite mine tailings mixture includes a total solids content, and further optionally wherein the at least one binding agent comprises less than 5 wt % of the total solids content, optionally including the at least one binding agent comprising less than 4 wt %, less than 2.5 wt %, less than 2 wt %, less than 1 wt %, less than 0.5 wt %, less than 0.25 wt %, less than 0.1 wt %, or less than 0.01 wt % of the total solids content.

A66. The method of paragraph A65, wherein the at least one binding agent includes at least one of a coagulant, a flocculent, gypsum, alum, a multivalent cation, an acid, a base, aluminum chlorohydrate, aluminum sulfate, calcium oxide, calcium hydroxide, iron(II) sulfate, iron(III) chloride, polyacrylamide, polydiallyldimethylammonium chloride, sodium aluminate, sodium silicate, chitosan, isinglass, moringa oleifera seeds, gelatin, strychnos, guar gum, and alginates.

A67. The method of any of paragraphs A65-A66, wherein the at least one binding agent includes an acid, and the method further includes adding the acid until a pH of the composite mine tailings mixture is less than 7.5, optionally including a pH of less than 7, less than 6.5, or less than 6.

A68. The method of any of paragraphs A65-A66, wherein the at least one binding agent includes a base, and the method further includes adding the base until a pH of the composite mine tailings mixture is greater than 10, optionally including a pH of greater than 10.5 or greater than 11.

A69. The method of any of paragraphs A1-A68, wherein the method further includes adding sand to at least one of the mine tailings, the portion of the plurality of wicking fibers, and the composite mine tailings mixture.

A70. The method of paragraph A69, wherein a sand-to-fines ratio in the composite mine tailings mixture is between 0.3 and 8, optionally including sand-to-fines ratios of 0.5-7, 0.8-5, 1-3.5, 1-3, and 1-4.

A71. The method of any of paragraphs A1-A70, wherein the composite mine tailings mixture includes sand, water, fine particles of less than 44 microns in diameter, and a coagulant.

A72. The method of paragraph A71, wherein a sand-to-fines ratio in the composite mine tailings mixture is less than 3.5 to 1.

A73. The method of any of paragraphs A1-A72, wherein the mine tailings include oil sands mine tailings, and further wherein the composite mine tailings mixture includes a non-segregating oil sands mine tailings mixture.

A74. The method of any of paragraphs A1-A73, wherein the composite mine tailings mixture includes a total solids content, and further wherein the plurality of wicking fibers comprise 0.0001 to 10 wt % of the total solids content, optionally including 0.1 to 1 wt %, 0.001 to 5 wt %, 5 to 10 wt %, 0.01 to 1 wt % of the total solids content, further optionally including less than 5 wt %, less than 0.5 wt %, less than 0.05 wt %, or less than 0.005 wt % of the total solids content.

A75. The method of any of paragraphs A1-A74, wherein providing the plurality of wicking fibers includes providing a wicking fibers stream including the plurality of wicking fibers.

A76. The method of any of paragraphs A1-A75, wherein the method further includes entraining at least a portion of the plurality of wicking fibers in a fluid to form a fiber slurry, and further wherein providing the plurality of wicking fibers includes providing the fiber slurry, and optionally wherein providing the plurality of wicking fibers includes providing a fiber slurry stream, wherein the fiber slurry stream includes the fiber slurry.

A77. The method of any of paragraphs A1-A76, wherein the plurality of wicking fibers includes one or more lengths that define an average length, and further wherein the average length is less than 2 meters, optionally including average lengths of less than 1 meter, less than 50 cm, less than 25 cm, less than 1 cm, less than 1 mm, less than 0.1 mm, or less than 0.01 mm, further optionally including average lengths that are between 0.01 mm and 2 meters, optionally including average lengths that are between 0.1 mm and 1 meter, 0.01 mm and 1 meter, 0.1 mm and 50 cm, 1 mm and 50 cm, 1 mm and 25 cm, or 1 cm and 50 cm.

A78. The method of any of paragraphs A1-A77, wherein the plurality of wicking fibers includes one or more characteristic diameters that define an average characteristic diameter, and further wherein the average characteristic diameter is less than 2.5 cm, optionally including average characteristic diameters of less than 2 cm, less than 1 cm, less than 5 mm, less than 3 mm, less than 1 mm, less than 0.5 mm, or characteristic diameters of less than 0.1 mm.

A79. The method of any of paragraphs A1-A78, wherein at least a portion of the plurality of wicking fibers includes a bio-fiber.

A80. The method of paragraph A79, wherein the bio-fiber includes at least one of wood chips, wood slash, wood pulp, grass, straw, hemp, hay, and cellulose.

A81. The method of any of paragraphs A79-A80, wherein the method further includes drying the bio-fiber prior to the mixing step.

A82. The method of any of paragraphs A1-A81, wherein at least a portion of the plurality of wicking fibers includes an artificial fiber.

A83. The method of paragraph A82, wherein the artificial fiber includes at least one of a polymer, polypropylene, glass, plastic, fiberglass, and a composite fiber.

A84. The method of any of paragraphs A1-A83, wherein the plurality of wicking fibers includes at least one of fabric, geofabric, rope, rods, capillary rods, permeable rods, and two or more twisted strands of fibers.

A85. The method of any of paragraphs A1-A84, wherein a dewatering rate for the composite mine tailings mixture is greater than a dewatering rate for a substantially similar mine tailings mixture that does not include the plurality of wicking fibers.

A86. The method of any of paragraphs A1-A85, wherein a fluid permeability of the composite mine tailings mixture is greater than a fluid permeability of a substantially similar mine tailings mixture that does not include the plurality of wicking fibers.

A87. The method of any of paragraphs A1-A86, wherein a mechanical stability of the composite mine tailings mixture is greater than a mechanical stability of a substantially similar mine tailings mixture that does not include the plurality of wicking fibers.

A88. The method of any of paragraphs A1-A87, wherein a shear strength of the composite mine tailings mixture is greater than a shear strength of a substantially similar mine tailings mixture that does not include the plurality of wicking fibers.

A89. The method of any of paragraphs A1-A88, wherein the method further includes dewatering the composite mine tailings mixture for a dewatering time, and further wherein a shear strength of the composite mine tailings mixture is at least 5 kPa after a dewatering time of one year, optionally including shear strengths that are at least 6 kPa, at least 7 kPa, at least 8 kPa, at least 9 kPa, or at least 10 kPa after a dewatering time of one year.

A90. The method of any of paragraphs A1-A89, wherein the method further includes dewatering the composite mine tailings mixture for a dewatering time, and further wherein a shear strength of the composite mine tailings mixture is at least 10 kPa after a dewatering time of five years, optionally including shear strengths of at least 12 kPa, at least 14 kPa, at least 16 kPa, at least 18 kPa, or at least 20 kPa after a dewatering time of five years.

A91. The method of any of paragraphs A1-A90, wherein the method further includes covering the composite mine tailings mixture with a capping material.

A92. The method of paragraph A91, wherein the capping material includes at least one of coke, sand, and mine overburden.

A93. The method of any of paragraphs A1-A92, wherein the mine tailings include a hydrocarbon, and optionally wherein the mine tailings include oil.

A94. The method of any of paragraphs A1-A93, wherein the mine tailings are a byproduct of an oil production operation.

A95. The method of any of paragraphs A1-A94, wherein the mine tailings are a byproduct of oil recovery from an oil sands deposit.

A96.A composite mine tailings mixture formed by the method of any one of paragraphs A1-A95.

A97.A composite mine tailings deposit formed by the method of any one of paragraphs A2-A95.

B1. A composite mine tailings mixture, comprising: sand;

mine tailings, wherein the mine tailings include fine particles;

water;

a binding agent; and

a plurality of wicking fibers, wherein the plurality of wicking fibers are dispersed within the composite mine tailings mixture.

B2. The composite mine tailings mixture of paragraph B1, wherein the composite mine tailings mixture further includes a hydrocarbon, and optionally wherein the hydrocarbon includes oil.

B3. The composite mine tailings mixture of any of paragraphs B1-B2, wherein the fine particles include at least one of clay particles and colloidal clay particles.

B4. The composite mine tailings mixture of any of paragraphs B1-B3, wherein the fine particles include a characteristic diameter, and further wherein the characteristic diameter of the fine particles is less than 60 micrometers, optionally including characteristic diameters of less than 55, less than 50, less than 45, less than 44, less than 40, or less than 35 micrometers.

B5. The composite mine tailings mixture of any of paragraphs B 1-B4, wherein a sand-to-fines ratio in the composite mine tailings mixture is between 0.3 and 8, optionally including sand-to-fines ratios of 0.5-7, 0.8-5, 0.5-3.5, 1-3.5, 1.5-3.5, 1-3, and 1-4.

B6. The composite mine tailings mixture of any of paragraphs B1-B5, wherein the composite mine tailings mixture includes less than 70 wt % water, optionally including less than 65 wt %, less than 60 wt %, less than 55 wt %, less than 50 wt %, less than 45 wt %, less than 40 wt % or less than 35 wt % water.

B7. The composite mine tailings mixture of any of paragraphs B1-B6, wherein the composite mine tailings mixture includes a total solids content, and further wherein the binding agent comprises less than less than 5 wt % of the total solids content, optionally including the binding agent comprising less than 4 wt %, less than 2.5 wt %, less than 2 wt %, less than 1 wt %, less than 0.5 wt %, less than 0.25 wt %, less than 0.1 wt %, or less than 0.01 wt % of the total solids content.

B8. The composite mine tailings mixture of any of paragraphs B1-B7, wherein the binding agent includes at least one of a coagulant, a flocculent, gypsum, alum, a multivalent cation, an acid, a base, aluminum chlorohydrate, aluminum sulfate, calcium oxide, calcium hydroxide, iron(II) sulfate, iron(III) chloride, polyacrylamide, polydiallyldimethylammonium chloride, sodium aluminate, sodium silicate, chitosan, isinglass, moringa oleifera seeds, gelatin, strychnos, guar gum, and alginates.

B9. The composite mine tailings mixture of any of paragraphs B1-B8, wherein the composite mine tailings mixture includes a total solids content, and further wherein the plurality of wicking fibers comprise 0.0001 to 10 wt % of the total solids content, optionally including 0.1 to 1 wt %, 0.001 to 5 wt %, 5 to 10 wt %, 0.01 to 1 wt % of the total solids content, further optionally including less than 5 wt %, less than 0.5 wt %, less than 0.1 wt %, less than 0.05 wt %, less than 0.01 wt %, or less than 0.005 wt % of the total solids content.

B10. The composite mine tailings mixture of any of paragraphs B1-B9, wherein at least a portion of the plurality of wicking fibers includes a bio-fiber, and optionally wherein the bio-fiber includes at least one of wood chips, wood slash, wood pulp, grass, straw, hemp, hay, and cellulose.

B11. The composite mine tailings mixture of any of paragraphs B1-B10, wherein at least a portion of the plurality of wicking fibers includes an artificial fiber, and optionally wherein the artificial fiber includes at least one of a polymer, polypropylene, glass, plastic, fiberglass, and a composite fiber.

B12. A storage area containing a volume of the composite mine tailings mixture of any of paragraphs B1-B11.

C1. A system for producing and dewatering the composite mine tailings mixture of any of paragraphs B1-B12, the system comprising:

a mine tailings delivery system adapted to receive a mine tailings supply stream and produce a mine tailings feed stream;

a wicking fiber delivery system adapted to provide a wicking fiber feed stream;

a mixing volume adapted to receive the mine tailings feed stream and the wicking fiber feed stream and produce a composite mine tailings mixture stream; and

a storage area adapted to receive the composite mine tailings mixture; and optionally a dewatering system adapted to withdraw water from the composite mine tailings mixture.

C2. The system of paragraph C1, wherein the mixing volume includes at least one of the storage area, a static mixer, a stirred tank, and an auger.

C3. The system of any of paragraphs C1-C2, wherein the wicking fiber feed stream includes at least one of a substantially dry stream and a slurry of the wicking fibers and a fluid, and optionally wherein the fluid includes at least one of water and a portion of the mine tailings supply stream.

C4. The system of any of paragraphs C1-C3, wherein the mine tailings delivery system further includes a settling pond adapted to produce a mature fine tailings stream, and further wherein the mine tailings feed stream includes the mature fine tailings stream.

C5. The system of any of paragraphs C1-C4, wherein the mine tailings delivery system further includes a cyclone separator adapted to separate the mine tailings supply stream into an overflow stream and an underflow stream, and further wherein the mine tailings feed stream includes the underflow stream.

C6. The system of any of paragraphs C 1-05, wherein the mine tailings delivery system further includes a screen adapted to separate the mine tailings supply stream into a fines stream and a rejects stream, and further wherein the mine tailings feed stream includes the fines stream.

C7. The system of any of paragraphs C1-C6, wherein the mine tailings delivery system further includes a primary separation vessel adapted to separate the mine tailings supply stream into a primary separation vessel tailings stream, an oil-rich stream, and a froth stream, and further wherein the mine tailings feed stream includes the primary separation vessel tailings stream.

C8. The system of paragraph C7, wherein the mine tailings delivery system further includes a flotation cell adapted to separate the oil-rich stream into a recovered oil stream and a recycle stream, and further wherein the recycle stream is returned to the primary separation vessel.

C9. The system of any of paragraphs C1-C8, wherein the dewatering system includes at least one of a sand layer, a sand column, a trench, a dyke, a rim ditch, a wick, a French drain, a drain pipe, and a sloped region.

C10. The system of any of paragraphs C1-C9, wherein the dewatering system includes an earth-moving device, and optionally wherein the earth-moving device is adapted to turn, rototill, aerate, disk, plow, or trench at least a portion of the composite mine tailings mixture.

C11. The system of any of paragraphs C1-C10, wherein the system further includes a composite mine tailings stream delivery system adapted to deliver the composite mine tailings stream from the mixing volume to the storage area, and optionally wherein the composite mine tailings stream delivery system includes at least one of a conveyor and a pump.

C12. The system of any of paragraphs C1-C11, wherein the system further includes a water recycle system adapted to accept a water stream from the dewatering system and supply the water stream to at least one of the mine tailings delivery system, the wicking fiber delivery system, and a mining operation.

C13. The system of any of paragraphs C1-C12, wherein the system further includes a binding agent delivery system adapted to supply a binding agent stream to at least one of the primary separation vessel and the mixing volume.

D1. The use of any of the methods of any of paragraphs A1-A95 with any of the systems of any of paragraphs C1-C13.

D2. The use of any of the systems of any of paragraphs C1-C13 with any of the methods of any of paragraphs A1-A95.

D3. The use of any of the methods of any of paragraphs A1-A95 to dewater mine tailings.

D4. The use of any of the methods of any of paragraphs A1-A95 to produce non-segregating mine tailings.

D5. The use of any of the methods of any of paragraphs A1-A95 to increase a mechanical strength of a mine tailings deposit.

D6. The use of any of the methods of any of paragraphs A1-A95 as part of an oil production operation.

D7. The use of any of the methods of any of paragraphs A1-A95 to produce trafficable land from a mine tailings deposit.

D8. The use of any of the systems of any of paragraphs C1-C13 to dewater mine tailings.

D9. The use of any of the systems of any of paragraphs C1-C13 to produce non-segregating mine tailings.

D10. The use of any of the systems of any of paragraphs C1-C13 to increase a mechanical strength of a mine tailings deposit.

D11. The use of any of the systems of any of paragraphs C1-C13 as part of an oil production operation.

D12. The use of any of the systems of any of paragraphs C1-C13 to produce trafficable land from a mine tailings deposit.

D13. The use of the method of any of paragraphs A1-A95 to produce the composite mine tailings mixture of any of paragraphs B1-B12.

D14. The use of the system of any of paragraphs C1-C13 to produce the composite mine tailings mixture of any of paragraphs B1-B12.

### INDUSTRIAL APPLICABILITY

The systems and methods disclosed herein are applicable to the mining and petroleum industries.

It is believed that the disclosure set forth above encompasses multiple distinct inventions with independent utility. While each of these inventions has been disclosed in its preferred form, the specific embodiments thereof as disclosed and illustrated herein are not to be considered in a limiting sense as numerous variations are possible. The subject matter of the inventions includes all novel and non-obvious combinations and subcombinations of the various elements, features, functions and/or properties disclosed herein. Similarly, where the claims recite “a” or “a first” element or the equivalent thereof, such claims should be understood to include incorporation of one or more such elements, neither requiring nor excluding two or more such elements.

It is believed that the following claims particularly point out certain combinations and subcombinations that are directed to one of the disclosed inventions and are novel and non-obvious. Inventions embodied in other combinations and subcombinations of features, functions, elements and/or properties may be claimed through amendment of the present claims or presentation of new claims in this or a related application. Such amended or new claims, whether they are directed to a different invention or directed to the same invention, whether different, broader, narrower, or equal in scope to the original claims, are also regarded as included within the subject matter of the inventions of the present disclosure.

1. A method of increasing a rate of dewatering of mine tailings, the method comprising:
providing a plurality of wicking fibers;
mixing at least a portion of the plurality of wicking fibers with mine tailings to form a composite mine tailings mixture; and
depositing the composite mine tailings mixture in a storage area as a composite mine tailings deposit.

2. The method of claim 1, wherein at least a portion of the plurality of wicking fibers within the composite mine tailings deposit is arranged randomly.

3. The method of claim 1, wherein the composite mine tailings deposit includes a primary wicking direction, and further wherein the method includes orienting a majority of the plurality of wicking fibers in the primary wicking direction.

4. The method of claim 1, wherein the mixing includes mixing the portion of the plurality of wicking fibers with the mine tailings prior to depositing the composite mine tailings mixture in the storage area.

5. The method of claim 1, wherein the mixing includes mixing the portion of the plurality of wicking fibers with the mine tailings concurrently with depositing the composite mine tailings mixture in the storage area.

6. The method of claim 1, wherein the mixing includes mixing the portion of the plurality of wicking fibers with the mine tailings in the storage area.

7. The method of claim 1, wherein the mixing includes injecting at least a portion of the plurality of wicking fibers into the mine tailings to form the composite mine tailings mixture.

8. The method of claim 1, wherein the depositing includes depositing the composite mine tailings mixture in a plurality of layers, and further wherein the plurality of layers includes at least a lower composite mine tailings mixture layer and an upper composite mine tailings mixture layer.

9. The method of claim 8, wherein, in the lower composite mine tailings mixture layer, a majority of the plurality of wicking fibers are oriented in a lower layer direction, wherein, in the upper composite mine tailings mixture layer, a majority of the plurality of wicking fibers are oriented in an upper layer direction, and further wherein the depositing includes depositing the lower composite mine tailings mixture layer and depositing the upper composite mine tailings mixture layer.

10. The method of claim 8, wherein the lower composite mine tailings mixture layer and the upper composite mine tailings mixture layer are separated by an intermediate layer, wherein the intermediate layer includes mine tailings, and further wherein the intermediate layer includes a lower concentration of wicking fibers than the composite mine tailings mixture, and further wherein the depositing includes depositing the lower composite mine tailings mixture layer, depositing the intermediate layer, and depositing the upper composite mine tailings mixture layer.

11. The method of claim 10, wherein the intermediate layer includes an intermediate layer thickness and at least one of the upper composite mine tailings mixture layer and the lower composite mine tailings mixture layer includes a composite mine tailings mixture layer thickness, and further wherein the intermediate layer thickness is different than the composite mine tailings mixture layer thickness.

12. The method of claim 1, the method further including dewatering the composite mine tailings mixture to produce removed water.

13. The method of claim 12, wherein the method includes capturing the removed water to produce captured water and recycling the captured water to a mining facility, and further wherein the method includes using the captured water in a mining process, and further wherein the method includes producing mine tailings as a byproduct of the mining process.

14. The method of claim 1, wherein the method further includes providing the mine tailings.

15. The method of claim 14, wherein providing the mine tailings includes providing fluid fine tailings, settling solids from the fluid fine tailings to produce thin fine tailings, and removing a portion of the water present in the thin fine tailings to produce densified tailings; and further wherein mixing at least a portion of the plurality of wicking fibers with the mine tailings includes mixing the densified tailings with the portion of the plurality of wicking fibers.

16. The method of claim 15, wherein removing a portion of the water present in the thin fine tailings includes gravitational settling and dewatering of the thin fine tailings for a densifying time to produce mature fine tailings, and further wherein mixing the densified tailings with the portion of the plurality of wicking fibers includes mixing the mature fine tailings with the portion of the plurality of wicking fibers.

17. The method of claim 15, wherein removing a portion of the water present in the thin fine tailings includes adding a flocculent to the thin fine tailings to flocculate at least a portion of the particles present within the thin fine tailings and produce thickened tailings, and further wherein mixing the densified tailings with the plurality of wicking fibers includes mixing the thickened tailings with the portion of the plurality of wicking fibers.

18. The method of claim 1, wherein the method further includes separating at least a portion of the mine tailings into an underflow stream and an overflow stream in a cyclone separator, and further wherein mixing at least a portion of the mine tailings with the portion of the plurality of wicking fibers includes mixing at least a portion of the underflow stream with the portion of the plurality of wicking fibers.

19. The method of claim 1, wherein the method further includes adding a binding agent to at least one of the mine tailings, the portion of the plurality of wicking fibers, and the composite mine tailings mixture.

20. The method of claim 1, wherein the method further includes adding sand to at least one of the mine tailings, the plurality of wicking fibers, and the composite mine tailings mixture.

21. The method of claim 20, wherein a sand-to-fines ratio in the composite mine tailings mixture is less than 5 to 1.

22. The method of claim 1, wherein the method further includes entraining at least a portion of the plurality of wicking fibers in a fluid to form a fiber slurry, and further wherein providing the plurality of wicking fibers includes providing the fiber slurry.

23. The method of claim 1, wherein at least a portion of the plurality of wicking fibers includes a bio-fiber, and further wherein the bio-fiber includes at least one of wood chips, wood slash, wood pulp, grass, straw, hemp, hay, and cellulose.

24. The method of claim 1, wherein the method further includes covering the composite mine tailings mixture with a capping material, and further wherein the capping material includes at least one of coke, sand, and mine overburden.

25. The method of claim 1, wherein the depositing includes depositing the composite mine tailings mixture on a sloped region of the storage area.

26. A composite mine tailings mixture, comprising:
sand;
mine tailings, wherein the mine tailings include fine particles;
water;
a binding agent;
a hydrocarbon; and
a plurality of wicking fibers, wherein the plurality of wicking fibers are dispersed within the composite mine tailings mixture.

27. The composite mine tailings mixture of claim 26, wherein the fine particles include a characteristic diameter, and further wherein the characteristic diameter of the fine particles is less than 44 micrometers.

28. The composite mine tailings mixture of claim 26, wherein a sand-to-fines ratio in the composite mine tailings mixture is between 0.5 and 3.5.

29. The composite mine tailings mixture of claim 28, wherein the sand-to-fines ratio in the composite mine tailings mixture is between 1.5 and 3.5.

30. The composite mine tailings mixture of claim 26, wherein the composite mine tailings mixture includes a total solids content, and further wherein the plurality of wicking fibers comprise less than 5 wt % of the total solids content.

31. The composite mine tailings mixture of claim 26, wherein at least a portion of the plurality of wicking fibers includes a bio-fiber, and further wherein the bio-fiber includes at least one of wood chips, wood slash, wood pulp, grass, straw, hemp, hay, and cellulose.

32. The composite mine tailings mixture of claim 26, wherein the plurality of wicking fibers have an average length of 0.1 mm to 50 cm.

33. The composite mine tailings mixture of claim 32, wherein the plurality of wicking fibers have an average length of 1 mm to 25 cm.

34. A system for producing and dewatering the composite mine tailings mixture of claim 26, the system comprising:
a mine tailings delivery system adapted to receive a mine tailings supply stream and produce a mine tailings feed stream;
a wicking fiber delivery system adapted to provide a wicking fiber feed stream;
a mixing volume adapted to receive the mine tailings feed stream and the wicking fiber feed stream and produce a composite mine tailings mixture stream;
a storage area adapted to receive the composite mine tailings mixture; and
a dewatering system adapted to withdraw water from the composite mine tailings mixture.

35. The system of claim 33, wherein the mine tailings delivery system further includes a settling pond adapted to produce a mature fine tailings stream, and further wherein the mine tailings feed stream includes the mature fine tailings stream.

36. The system of claim 33, wherein the mine tailings delivery system further includes a cyclone separator adapted to separate the mine tailings supply stream into an overflow stream and an underflow stream, and further wherein the mine tailings feed stream includes the underflow stream.

37. The system of claim 33, wherein the system further includes a binding agent delivery system adapted to supply a binding agent stream to the mixing volume.
